(19) United States
(12) Patent Application Publication
(10) Pub. No.: US 2026/0249811 A1
(43) Pub. Date: Aug. 27, 2026

(54) AUTHENTICATION CONDITIONS FOR STARTING A VEHICLE

(71) Applicant: Ford Global Technologies, LLC, Dearborn, MI (US)

(72) Inventors: Rami Al Khatib, Dearborn, MI (US); John Robert Van Wiemeersch, Novi, MI (US); Mahmoud Yousef Ghannam, Canton, MI (US); Mansoor Nasir, Canton, MI (US)

(73) Assignee: Ford Global Technologies, LLC, Dearborn, MI (US)

(21) Appl. No.: 19/064,838

(22) Filed: Feb. 27, 2025

(51) Int. Cl. B60R 25/24; B60R 25/04; B60R 25/102; B60R 25/25; B60R 25/31; G06N 3/0442; G07C 9/00; G07C 9/20

(52) U.S. Cl. CPC B60R 25/24; B60R 25/04; B60R 25/102; B60R 25/25; B60R 25/31; G06N 3/0442; G07C 9/00309; G07C 9/20; B60R 2325/205; G07C 2009/00769; G07C 2209/63

(57) ABSTRACT

A computer includes a processor and a memory, and the memory stores instructions executable by the processor to, while a vehicle is off, detect an anomaly in an external environment surrounding the vehicle by executing a long short-term memory algorithm; in response to detecting the anomaly, permit starting the vehicle upon receiving a multifactor authentication, and block starting the vehicle without receiving the multifactor authentication; and, in response to not detecting the anomaly, permit starting the vehicle upon receiving a single-factor authentication. Sensor data measuring the external environment is an input to the long short-term memory algorithm.

### BACKGROUND

Vehicles are switchable between different power states, such as an on state, an off state, and an accessory-power state. In the on state, full electrical energy is provided to electrical components of the vehicle and the vehicle is ready to be driven. In the off state, a low amount of electrical energy is provided to selected electrical components of the vehicle. The off state is typically used when the vehicle is being stored, and the vehicle is not ready to be driven. In the accessory-power state, full electrical energy is provided to more electrical components than in the off state, and the vehicle is not ready to be driven. Typically, an operator puts the vehicle into the on state when the operator is going to drive the vehicle, puts the vehicle into the off state when the operator is going to leave the vehicle, and puts the vehicle into the accessory-power state when the operator is going to sit in the vehicle but not drive the vehicle.

### BRIEF DESCRIPTION OF THE DRAWINGS

FIG. 1 is a block diagram of an example vehicle.

FIG. 2 is a flowchart of an example process for permitting or blocking starting the vehicle.

### DETAILED DESCRIPTION

This disclosure pertains to contextually determining conditions for starting a vehicle. One or more sensors on board the vehicle may receive sensor data measuring an external environment surrounding the vehicle, such as image data from a camera. The computer may detect whether any anomalies are present by executing a long short-term memory algorithm, taking the sensor data as an input. Examples of anomalies may include a person holding a tool, a person wearing a face covering, etc. A long short-term memory algorithm is a type of recurrent neural network, and this particular algorithm is useful in this situation for detecting suspicious patterns over time, rather than relying solely on a snapshot of information. In response to detecting an anomaly, the computer permits starting the vehicle upon receiving a multifactor authentication, and blocks starting the vehicle without receiving the multifactor authentication. In response to not detecting the anomaly, the computer permits starting the vehicle upon receiving a single-factor authentication. Switching to multifactor authentication in response to an anomaly can make it more difficult for potential thieves to use techniques such as lock-picking or CAN injection. CAN injection involves partially disassembling the vehicle to gain access to CAN bus wiring, and then sending signals through the CAN bus to attempt to start the vehicle.

A computer includes a processor and a memory, and the memory stores instructions executable by the processor to, while a vehicle is off, detect an anomaly in an external environment surrounding the vehicle by executing a long short-term memory algorithm; in response to detecting the anomaly, permit starting the vehicle upon receiving a multifactor authentication, and block starting the vehicle without receiving the multifactor authentication; and, in response to not detecting the anomaly, permit starting the vehicle upon receiving a single-factor authentication. Sensor data measuring the external environment is an input to the long short-term memory algorithm.

In an example, the long short-term memory algorithm may be more likely to detect an anomaly in response to the sensor data indicating a person holding a tool.

In an example, the long short-term memory algorithm may be more likely to detect an anomaly in response to the sensor data indicating a person wearing a face covering.

In an example, a current location of the vehicle may be an input to the long short-term memory algorithm.

In an example, sensors that produce the sensor data may be inactive by default when the vehicle is off, and the instructions may further include instructions to, in response to receiving data indicating motion of the vehicle while the vehicle is off, activate the sensors.

In an example, sensors that produce the sensor may be are inactive by default when the vehicle is off, and the instructions may further include instructions to, in response to an attempt to start the vehicle while the vehicle is off, activate the sensors.

In an example, the instructions may further include instructions to determine a location score of a current location of the vehicle and, in response to the location score exceeding a threshold, permit starting the vehicle upon insertion of a physical key into the vehicle and block starting the vehicle without insertion of the physical key into the vehicle.

In an example, the instructions may further include instructions to, in response to detecting the anomaly and detecting a mobile device of an operator of the vehicle within range of the vehicle, permit starting the vehicle upon receiving an authentication via the mobile device. In a further example, the instructions may further include instructions to, in response to detecting the anomaly and not detecting the mobile device within range of the vehicle, permit starting the vehicle upon receiving a biometric authentication.

In an example, the instructions may further include instructions to, in response to detecting the anomaly, lock the vehicle.

In an example, the instructions may further include instructions to, in response to detecting the anomaly, transmit a message to a mobile device of an operator of the vehicle.

In an example, the instructions may further include instructions to, in response to detecting the anomaly, transition the vehicle to a lockdown mode in which CAN bus messages to start the vehicle are disregarded.

In an example, the instructions may further include instructions to, in response to detecting the anomaly and not detecting a mobile device of an operator of the vehicle within range of the vehicle, determine an anomaly score for the anomaly. In a further example, the instructions may further include instructions to, in response to the anomaly score exceeding a threshold, permit starting the vehicle upon receiving a multifactor authentication, and block starting the vehicle without receiving the multifactor authentication.

A method includes, while a vehicle is off, detecting an anomaly in an external environment surrounding the vehicle by executing a long short-term memory algorithm; in response to detecting the anomaly, permitting starting the vehicle upon receiving a multifactor authentication, and blocking starting the vehicle without receiving the multifactor authentication; and, in response to not detecting the anomaly, permitting starting the vehicle upon receiving a single-factor authentication. Sensor data measuring the external environment is an input to the long short-term memory algorithm.

In an example, the long short-term memory algorithm may be more likely to detect an anomaly in response to the sensor data indicating a person holding a tool.

In an example, the long short-term memory algorithm may be more likely to detect an anomaly in response to the sensor data indicating a person wearing a face covering.

In an example, sensors that produce the sensor data may be inactive by default when the vehicle is off, and the method may further include, in response to receiving data indicating motion of the vehicle while the vehicle is off, activating the sensors.

In an example, sensors that produce the sensor data may be inactive by default when the vehicle is off, and the method may further include, in response to an attempt to start the vehicle while the vehicle is off, activating the sensors.

In an example, the method may further include determining a location score of a current location of the vehicle and, in response to the location score exceeding a threshold, permitting starting the vehicle upon insertion of a physical key into the vehicle and blocking starting the vehicle without insertion of the physical key into the vehicle.

With reference to the Figures, wherein like numerals indicate like parts throughout the several views, a computer 105 includes a processor and a memory, and the memory stores instructions executable by the processor to, while a vehicle 100 is off, detect an anomaly in an external environment surrounding the vehicle 100 by executing a long short-term memory algorithm; in response to detecting the anomaly, permit starting the vehicle 100 upon receiving a multifactor authentication, and block starting the vehicle 100 without receiving the multifactor authentication; and, in response to not detecting the anomaly, permit starting the vehicle 100 upon receiving a single-factor authentication. Sensor data measuring the external environment is an input to the long short-term memory algorithm.

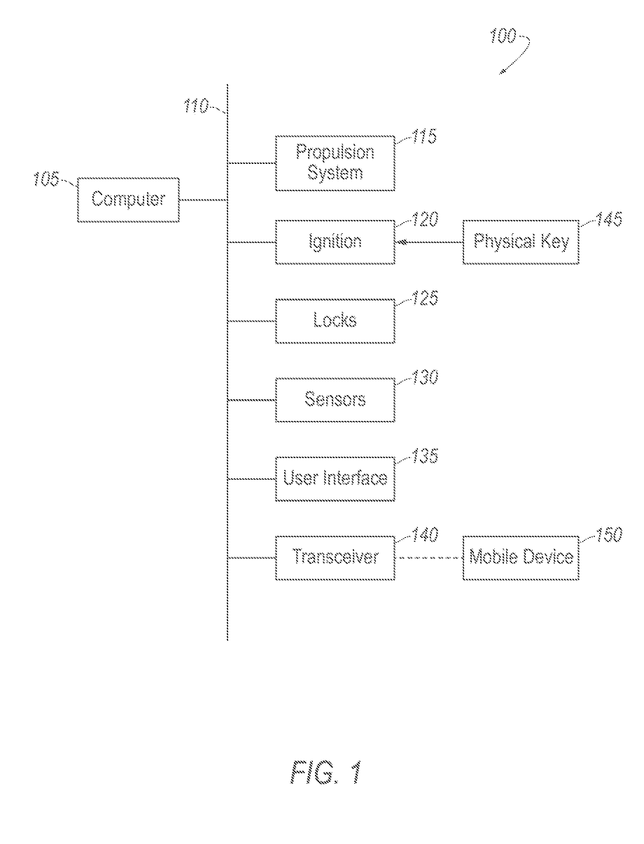

With reference to FIG. 1, the vehicle 100 may be any passenger or commercial automobile such as a car, a truck, a sport utility vehicle, a crossover, a van, a minivan, a taxi, a bus, etc. The vehicle 100 may include the computer 105, a communications network 110, a propulsion system 115, an ignition 120, locks 125, sensors 130, a user interface 135, and a transceiver 140.

The computer 105 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 110. The communications network 110 may be a controller area network (CAN) bus, Ethernet, WiFi, Local Interconnect Network (LIN), onboard diagnostics connector (OBD-II), and/or any other wired or wireless communications network. The computer 105 may be communicatively coupled to the propulsion system 115, the ignition 120, the locks 125, the sensors 130, the user interface 135, the transceiver 140, and other components via the communications network 110.

The propulsion system 115 of the vehicle 100 generates energy and translates the energy into motion of the vehicle 100. The propulsion system 115 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 115 can include an electronic control unit (ECU) or the like that is in communication with and receives input from the computer 105 and/or a human operator. The human operator may control the propulsion system 115 via, for example, a pedal and/or a gear-shift lever.

The ignition 120 is located in a passenger compartment of the vehicle 100 and operates to start the vehicle 100. The ignition 120 can be movable by the operator between, for example, an off state, an on state, an accessories state, and a starting state (for a barrel-type), or between a transition state and a static state (for a pushbutton). For example, the ignition 120 can be a barrel rotatable between positions corresponding to the states, or the ignition 120 can be a push button that is in the transition state when pressed. The ignition 120 can be biased to move out of the starting position or transition position (e.g., by having a spring that rotationally biases the barrel from the starting position to the on position or biases the button from the pressed position to the unpressed position). For an internal-combustion vehicle, the ignition 120 can be electrically connected to a battery that is configured to supply power to a starter in response to a signal from the ignition 120. For example, when the ignition 120 is in the starting state, the ignition 120 can supply power from the battery to a solenoid, causing the solenoid to close and thereby complete a circuit for current to flow from the battery to the starter. For an electric vehicle, the ignition 120 can establish an electrical connection for the batteries to power the vehicle 100.

Starting the vehicle 100 may be dependent on insertion of a physical key 145 into the vehicle 100 (e.g., into the ignition 120). The physical key 145 may engage the ignition 120 when inserted to, for example, permit the barrel to rotate or otherwise move to the starting state. For example, a blade of the physical key 145 may include profile contours and/or a pattern of bitting cuts. The ignition 120 may be configured to accept a specific pattern of the bitting cuts, and the ignition 120 may be startable only when a physical key 145 with the correct pattern is inserted.

The locks 125 are engageable to permit or prevent doors of the vehicle 100 from being opened. The locks 125 are movable between a disengaged position, in which the doors are unlocked (i.e., permitted to open if the door handle is operated), and an engaged position, in which the doors are locked (i.e., prevented from opening even if the door handle is operated).

Starting the vehicle 100 may be dependent on access to the vehicle 100. Part of permitting starting of the vehicle 100 is permitting access to the vehicle 100 by unlocking the locks 125. Blocking starting of the vehicle 100 may be achieved by locking the locks 125 so that a person does not have access to the vehicle 100 (possibly in addition to other actions).

The sensors 130 may provide data about operation of the vehicle 100, for example, wheel speed, wheel orientation, and engine and transmission data (e.g., temperature, fuel consumption, etc.). The sensors 130 may detect the location and/or orientation of the vehicle 100. For example, the sensors 130 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 130 may detect the external world, including objects and/or characteristics of surroundings of the vehicle 100, such as other vehicles, road lane markings, traffic lights and/or signs, road users, etc. For example, the sensors 130 may include radar sensors, ultrasonic sensors, scanning laser range finders, light detection and ranging (lidar) devices, and image processing sensors such as cameras.

The user interface 135 presents information to and receives information from an operator of the vehicle 100. The user interface 135 may be located on an instrument panel in a passenger compartment of the vehicle 100, and/or wherever it may be readily seen by the operator. The user interface 135 may include dials, digital readouts, screens, speakers, and so on for providing information to the operator, such as human-machine interface (HMI) elements such as are known. The user interface 135 may include buttons, knobs, keypads, a microphone, and so on for receiving information from the operator.

The transceiver 140 may be adapted to transmit signals wirelessly through any suitable wireless communication protocol, such as cellular, Bluetooth®, Bluetooth® Low Energy (BLE), ultra-wideband (UWB), Wi-Fi, IEEE 802.11a/b/g/p, cellular-V2X (CV2X), Dedicated Short-Range Communications (DSRC), other RF (radio frequency) communications, etc. The transceiver 140 may be adapted to communicate with a remote server, that is, a server distinct and spaced from the vehicle 100. The remote server may be located outside the vehicle 100. For example, the remote server may be associated with another vehicle (e.g., V2V communications), an infrastructure component (e.g., V2I communications), a first responder, a mobile device 150 associated with the operator of the vehicle 100, etc. The transceiver 140 may be one device or may include a separate transmitter and receiver.

The mobile device 150 is a portable computing device such as a mobile phone (e.g., a smartphone), a tablet, a smart key fob, a wearable device such as a smart watch, etc. The mobile device 150 is a computing device including a processor and a memory. The mobile device 150 is owned and carried by a person who may be the operator of the vehicle 100.

The vehicle 100 is switchable between different power states, such as an on state, an off state, and an accessory-power state. For the purposes of this disclosure, “on state” is defined as the state of the vehicle 100 in which full electrical energy is provided to electrical components of the vehicle 100 and the vehicle 100 is ready to be driven (i.e., the propulsion system 115 is operable); “off state” is defined as the state of the vehicle 100 in which a low amount of electrical energy is provided to selected electrical components of the vehicle 100, typically used when the vehicle 100 is being stored, and the vehicle 100 is not ready to be driven; and “accessory-power state” is defined as the state of the vehicle 100 in which full electrical energy is provided to more electrical components than in the off state and the vehicle 100 is not ready to be driven. Typically, an operator puts the vehicle 100 into the on state when the operator is going to operate the propulsion system 115 of the vehicle 100, puts the vehicle 100 into the off state when the operator is going to leave the vehicle 100, and puts the vehicle 100 into the accessory-power state when the operator is going to sit in the vehicle 100 but not operate the propulsion system 115. For the purposes of this disclosure, the expression “starting the vehicle” is defined as putting the vehicle 100 into the on state.

Whether specific sensors 130 are active or inactive may depend on the power state of the vehicle 100 (i.e., whether the vehicle 100 is in the on state, off state, or accessory-power state). A sensor 130 is active when generating data or ready to generate data according to what the sensor 130 detects, and a sensor 130 is inactive when not ready to generate data according to what the sensor 130 detects. Certain sensors 130 may be inactive by default when the vehicle 100 is in the off state. The sensors 130 that are inactive by default when the vehicle 100 is off may be chosen based on the power draw of the sensors 130 and the uses of the sensor data produced by the sensors 130. For example, cameras and/or other environmental sensors of the sensors 130 may be inactive by default when the vehicle 100 is off. As described below, certain sensors 130 that are inactive by default when the vehicle 100 is off may be activated while the vehicle 100 is still off in response to specific conditions being met.

An operator may be able to start the vehicle 100 (i.e., put the vehicle 100 into the on state) in multiple ways. For example, the operator may insert the physical key 145 into the vehicle 100, as described above. For another example, the operator may use a pushbutton to start the vehicle 100 while a keyfob is detected inside the passenger compartment of the vehicle 100. The keyfob may include an RFID tag or the like for uniquely identifying the keyfob. For another example, the operator may instruct the mobile device 150 to transmit a command to the vehicle 100 via the transceiver 140 to start the vehicle 100. As part of starting the vehicle 100 according to some of these methods (e.g., the physical key 145, pushbutton and keyfob), the operator may first need to access the vehicle by unlocking the locks 125 to enter the passenger compartment. As will be described below, conditions may be placed on whether each of these methods is permitted to start the vehicle 100, and the conditions may be different for different methods.

The computer 105 may be programmed to transition the vehicle 100 between different lockdown-related modes. The lockdown-related modes include a non-lockdown mode and one or more lockdown modes. Each lockdown-related mode may specify whether certain security features are engaged. For example, in the lockdown mode, the computer 105 may actuate the locks 125 to lock, and CAN bus messages transmitted over the communications network 110 to start the vehicle 100 may be disregarded (by the computer 105 and/or other components). As a result, the operator may be able to start the vehicle 100 with the physical key 145 or keyfob but not with the mobile device 150. As a result, the computer 105 transitioning the vehicle 100 to the lockdown mode blocks starting the vehicle 100 with the mobile device 150. In the non-lockdown mode, the computer 105 may maintain the locks 125 in a current state (i.e., either as locked or as unlocked), and CAN bus messages transmitted over the communications network 110 to start the vehicle 100 may be permitted to start the vehicle 100.

The computer 105 may be programmed to transition between an activatable mode and deactivated mode. In the activatable mode, the computer 105 implements the conditions on starting the vehicle 100, as described below. In the deactivated mode, the computer 105 starts the vehicle 100 upon use of any of the methods for starting the vehicle 100 described above, without applying the conditions described below. The computer 105 may transition into the activatable mode upon receiving an input via the user interface 135. The computer 105 may transition into the deactivated mode upon receiving an input via the user interface 135 while the vehicle 100 is in the on state, and not transition into the deactivated mode in response to the vehicle 100 being in the off state. Alternatively or additionally, the computer 105 may transition into the deactivated mode upon receiving an input via the user interface 135 from an authorized operator while the vehicle 100 is in the on state, and not transition into the deactivated mode in response to the vehicle 100 being in the off state or the operator not being an authorized operator. The computer 105 may identify the operator via a keyfob, mobile device 150, facial recognition, log-in process through the user interface 135, etc. An authorized operator may designated other operators of the vehicle 100 as authorized or not. As one example, a person may designate a family member as not an authorized operator, meaning that the family member is only permitted to operate the vehicle 100 while the computer 105 is in the activatable mode, and may not transition to the deactivated mode.

The computer 105 may be programmed to determine that an activation indication occurred. For the purposes of this disclosure, an “activation indication” is a circumstance indicating that, while the vehicle 100 is in the off state, an attempt is being made to either start or move the vehicle 100. For example, the activation indication may be data indicating motion of the vehicle 100 while the vehicle 100 is off (e.g., because the vehicle 100 is being towed or lifted). The computer 105 may determine that the vehicle 100 is moving while off based on data from, for example, an IMU or accelerometer of the sensors 130, which may be active while the vehicle 100 is in the off state. For another example, the activation indication may be an attempt to start the vehicle 100 while the vehicle 100 is off (e.g., by one of the methods described above).

The computer 105 may be programmed to, upon determining that an activation indication occurred (e.g., an attempt to start the vehicle 100 while the vehicle 100 is off or receiving data indicating motion of the vehicle 100 while the vehicle 100 is off), activate certain sensors 130. The activated sensors 130 begin generating sensor data as a result of being activated. The computer 105 may activate the sensors 130 that produce sensor data used to detect anomalies, as described below. For example, the computer 105 may activate cameras or other environmental sensors of the sensors 130. Accordingly, the cameras or other environmental sensors may begin generating sensor data measuring the external environment surrounding the vehicle 100.

For the purposes of this disclosure, an “anomaly” is defined as an occurrence in an environment that is unusual for that environment. Anomalies may be chosen for detection based on increasing a likelihood of unauthorized use or movement of the vehicle 100. Examples of anomalies may include a person holding a tool, a person wearing a face covering, another vehicle parked at an unusual proximity and orientation relative to the vehicle 100, etc. One use of a tool may be to gain access to components of the vehicle 100. One use of a mask may be to elude identification. A vehicle parked at an unusual orientation close to the vehicle 100 may be used to shield a person’s behavior at the vehicle 100 from view. Anomalies may also be series of events, such as a person holding a tool or wearing a mask, then moving into a specific position with respect to the vehicle 100 (e.g., kneeling near the headlights at the front end), and then remaining at the position for a certain length of time. This sequence of behavior is consistent with CAN injection.

The computer 105 is programmed to, while the vehicle 100 is off, detect an anomaly in the external environment surrounding the vehicle 100. The computer 105 detects the anomaly by executing a long short-term memory algorithm. The inputs to the long short-term memory algorithm include the sensor data and may also include a current location of the vehicle 100 and/or a current time (e.g., time of day, day of the week, date, etc.). The output of the long short-term memory algorithm may include an identification of an object in the environment as a specific type of anomaly (or the lack of any anomalies), and an anomaly score (described below). For example, the long short-term memory algorithm may output an identification of a person holding a tool, or of a possible CAN injection (e.g., as a series of events including a person holding a tool, kneeling next to the headlight, and remaining there for a period of time).

The term “long short-term memory algorithm” is used in its machine-learning sense as a recurrent neural network aimed at mitigating the effects of vanishing gradient. The structure of the neural network includes units composed of a cell and three gates: an input gate, an output gate, and a forget gate. The cell remembers values over arbitrary time intervals, and the gates control the flow of information into and out of the cell. Forget gates decide what information to discard from the previous state, by mapping the previous state and the current input to a value between 0 and 1. A value of 1 (after rounding) signifies retention of the information, and a value of 0 (after rounding) represents discarding. Input gates decide which pieces of new information to store in the current cell state, using the same system as forget gates. Output gates control which pieces of information in the current cell state to output, by assigning a value from 0 to 1 to the information, considering the previous and current states. Selectively outputting relevant information from the current state allows the long short-term memory algorithm to maintain useful, long-term dependencies to make predictions, both in current and future time-steps. The long short-term memory algorithm is thus especially useful for detecting a series of events, such as the series of events indicating a likely CAN injection described above.

The long short-term memory algorithm may be trained to detect specific anomalies. The long short-term memory algorithm may be trained using any training technique suitable for a long short-term memory algorithm, such as gradient descent (or another optimization algorithm) with backpropagation, correctionist temporal classification, policy gradient methods, etc. The training data may be a set of sequences of sensor data paired with ground-truth annotations. For example, the training data may be sequences of image data, with each sequence labeled with a specific type of anomaly (e.g., potential CAN injection, potential lock-picking) or as not depicting an anomaly. As a result of the selection of training data, the long short-term memory algorithm may be more likely to detect an anomaly in response to the sensor data indicating a person holding a tool or indicating a person wearing a face covering, as these events are included in image sequences labeled as anomalies.

The computer 105 may be programmed to, in response to detecting the anomaly, perform one or more actions. For example, the computer 105 may transition the vehicle 100 to the lockdown mode. The computer 105 may thus lock the vehicle 100 and disregard CAN bus messages to start the vehicle 100, as described above. Additionally, the computer 105 may transmit a message to the mobile device 150 of the operator. The computer 105 may actuate the transceiver 140 to transmit the message. The message may state the type of anomaly detected and/or notify the operator that the vehicle 100 has transitioned to the lockdown mode. The message may prompt the operator to respond whether the operator was responsible for the anomaly.

The computer 105 may be programmed to determine whether the mobile device 150 of the operator is within range of the vehicle 100. For example, the transceiver 140 may have an approximate radius within which the transceiver 140 is able to detect signals from mobile devices. When a mobile device is within the range of the transceiver 140, the computer 105 may establish a connection in which the mobile device 150 is identified as a known mobile device. The connection may include a negotiation between the detected mobile device 150 and the transceiver 140. Each negotiation identifies the transceiver 140 to the detected mobile device 150 and identifies the detected mobile device 150 to the transceiver 140, permitting signals to be transmitted between the transceiver 140 and the mobile device 150. The computer 105 may determine whether a detected mobile device 150 is a known mobile device based on identifying data included in signals from the mobile device 150.

Once the computer 105 detects an anomaly, the conditions under which the vehicle 100 is permitted to start may depend on whether the mobile device 150 of the operator is within range of the vehicle 100. The computer 105 may be programmed to, in response to detecting the mobile device 150 within range of the vehicle 100, permit starting the vehicle 100 upon receiving an authentication via the mobile device 150. The computer 105 may be further programmed to, in response to detecting the anomaly and not detecting the mobile device 150 within range of the vehicle 100, permit starting the vehicle 100 upon receiving a biometric authentication or multifactor authentication (but not a single-factor authentication through the mobile device 150), as will be described below. Having control over the mobile device 150 within the vicinity of the vehicle 100 serves as a layer of security, and an additional layer of security may be implemented when this is not true (i.e., biometric or multifactor authentication).

The computer 105 may be programmed to permit starting the vehicle 100 upon receiving an authentication via the mobile device 150. For example, the computer 105 may transmit a security code (such as a one-time code) to the mobile device 150, and the operator may enter the security code into the user interface 135. Alternatively, the security code may be generated by an authenticator app installed on the mobile device 150. For another example, the computer 105 may transmit a push notification to the mobile device 150 through near-field communication (NFC) or ultra-wideband (UWB). The use of NFC or UWB verifies the connection established with the mobile device 150.

The computer 105 may be programmed to determine an anomaly score for the anomaly. The anomaly score may indicate a confidence that an anomaly was detected. The anomaly score may be an output of the long short-term memory algorithm. For example, the long short-term memory algorithm may generate a score for each type of anomaly (and no anomaly), and identify the type with the highest score as the anomaly. The score of the identified type is the anomaly score.

The conditions under which the vehicle 100 is permitted to start may depend on whether the anomaly score exceeds a threshold. The threshold may be a preset value stored in the memory of the computer 105. The threshold may be chosen to indicate a high likelihood of the anomaly occurring. For example, the computer 105 may be programmed to, in response to the anomaly score exceeding a threshold, permit starting the vehicle 100 upon receiving a multifactor authentication, and block starting the vehicle 100 without receiving the multifactor authentication. The computer 105 may be programmed to, in response to the anomaly score being below the threshold, permit starting the vehicle 100 upon insertion of the physical key 145 into the vehicle 100 or upon an input provided to the user interface 135 (with the choice depending on conditions described below). The authentication needed can thus be customized to the likelihood of an anomaly.

The computer 105 may be programmed to permit starting the vehicle 100 upon receiving a multifactor authentication, and block starting the vehicle 100 without receiving the multifactor authentication. For the purposes of this disclosure, “multifactor authentication” is defined as granting access to a feature (e.g., ability to start the vehicle 100) only after successful presentation of at least two pieces of evidence that the presenter is permitted to access the feature. Examples of pieces of evidence include a password previously set by the operator, a one-time code (either transmitted to the mobile device 150 or generated by an authenticator app on the mobile device 150), a biometric authentication (described below), presence of the keyfob, use of phone-as-a-key (PaaK), insertion of the physical key 145, etc.

The computer 105 may be programmed to permit starting the vehicle 100 upon receiving a single-factor authentication. For the purposes of this disclosure, “single-factor authentication” is defined as granting access to a feature only after successful presentation of at least one piece of evidence that the presenter is permitted to access the feature. Examples of pieces of evidence include the user-set password, the one-time code, the biometric authentication, the presence of the keyfob, use of PaaK, the insertion of the physical key 145, etc.

The computer 105 may be programmed to determine a location score of a current location of the vehicle 100. The location score may indicate a likelihood of vehicular theft associated with the current location of the vehicle 100. The current location of the vehicle 100 may be provided by a GPS sensor of the sensors 130. For example, certain geographic areas defined by geofencing may have preassigned location scores, and the computer 105 may determine whether the current location of the vehicle 100 is contained with any of the geofencing. For example, a garage, plot, or neighborhood recorded as a “home” of the operator of the vehicle 100 may have a preassigned lower value for the location score, and other areas may have a preassigned higher score. When the current location of the vehicle 100 is within the geofencing recorded as home, the location score is the preassigned lower value; otherwise, the location score is the preassigned higher value.

The conditions under which the vehicle 100 is permitted to start may depend on whether the location score exceeds a threshold. The threshold may be a preset value stored in the memory of the computer 105. The threshold may be chosen to distinguish known trusted areas from other areas. For example, the computer 105 may be programmed to, in response to the location score exceeding a threshold, permit starting the vehicle 100 upon insertion of a physical key 145 into the vehicle 100, and block starting the vehicle 100 without insertion of the physical key 145 into the vehicle 100, as described above. The computer 105 may be programmed to, in response to the location score being below the threshold, permit starting the vehicle 100 upon receiving a single-factor authentication. For example, the computer 105 may, in response to the location score being below the threshold, permit starting the vehicle 100 upon receiving a biometric authentication, and block starting the vehicle 100 without the biometric authentication. The biometric authentication may provide a secure method to start the vehicle 100 in the absence of the mobile device 150.

The computer 105 may be programmed to permit starting the vehicle 100 upon receiving a biometric authentication, and block starting the vehicle 100 without receiving the biometric authentication. The data for the biometric authentication may be recorded by a component of the vehicle 100. The computer 105 may use any suitable type of biometric authentication, such as a retinal scan based on image data from a camera of the sensors 130, facial recognition based on the image data from the camera, a fingerprint scan on the user interface 135, voice recognition using a microphone of the user interface 135, etc.

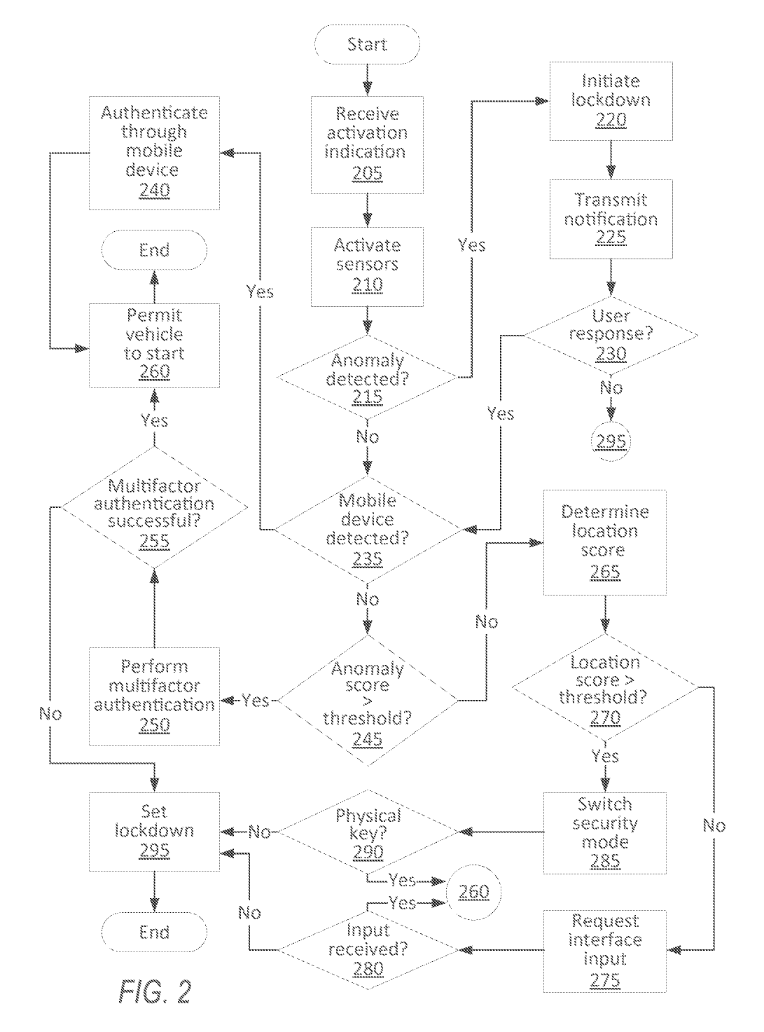

FIG. 2 is a flowchart illustrating an example process 200 for permitting or blocking starting the vehicle 100. The memory of the computer 105 stores executable instructions for performing the steps of the process 200 and/or programming can be implemented in structures such as mentioned above. As a general overview of the process 200, the process 200 begins in response to the computer 105 detecting an activation indication. The computer 105 then activates the sensors 130. In response to detecting an anomaly, the computer 105 transitions the vehicle 100 to the lockdown mode and transmits a message to the mobile device 150. In response to an input through the mobile device 150 after detecting the anomaly or in response to not detecting the anomaly, the computer 105 receives the authentication through the mobile device 150 and permits the vehicle 100 to start. In the absence of the input through the mobile device 150, the computer 105 maintains the lockdown mode and blocks starting the vehicle 100. In response to not detecting the mobile device 150, the computer 105 determines whether the anomaly score exceeds the threshold. If so, the computer 105 permits starting the vehicle 100 upon receiving a multifactor authentication, and blocks starting the vehicle 100 without receiving the multifactor authentication. Otherwise, the computer 105 determines the location score. In response to the location score exceeding the threshold, the computer 105 transitions the vehicle 100 to the lockdown mode, and the computer 105 permits starting the vehicle 100 upon insertion of a physical key 145 into the vehicle 100, and blocks starting the vehicle 100 without insertion of the physical key 145 into the vehicle 100. In response to the location score being below the threshold, the computer 105 permits starting the vehicle 100 upon receiving a single-factor authentication, and blocks starting the vehicle 100 without receiving the single-factor authentication. Upon either the vehicle 100 starting or the lockdown mode being maintained, the process 200 ends.

The process 200 begins in a block 205, in which the computer 105 determines that the activation indication has occurred (e.g., upon receiving data indicating motion of the vehicle 100 while the vehicle 100 is off, or in response to an attempt to start the vehicle 100 while the vehicle 100 is off), as described above.

Next, in a block 210, the computer 105 activates the sensors 130, as described above.

Next, in a block 215, the computer 105 determines whether an anomaly is detected in the external environment surrounding the vehicle 100 by executing a long short-term memory algorithm, as described above. In response to detecting the anomaly, the process 200 proceeds to a block 220. In response to not detecting the anomaly, the process 200 proceeds to a decision block 235.

In the block 220, the computer 105 transitions the vehicle 100 to the lockdown mode, as described above.

Next, in a block 225, the computer 105 transmits a message to the mobile device 150, as described above.

Next, in a decision block 230, the computer 105 determines whether the operator provided a response to the message transmitted to the mobile device 150. The response may indicate that the operator is the one attempting to access the vehicle 100. For example, the message may state something similar to the following: “An attempt was made to access your vehicle. Was this you?” The response may be a button labeled “Yes.” In response to receiving the response from the operator, the process 200 proceeds to the decision block 235. In response to not receiving the response from the operator within a time limit or receiving a contrary response (e.g., a button labeled “No”), the process 200 proceeds to a block 295.

In the decision block 235, the computer 105 determines whether the mobile device 150 is detected within range of the vehicle 100, as described above. In response to detecting the mobile device 150 within range of the vehicle 100, the process 200 proceeds to a block 240. In response to not detecting the mobile device 150 within range of the vehicle 100, the process 200 proceeds to a decision block 245.

In the block 240, the computer 105 receives the authentication via the mobile device 150, as described above. After the block 240, the process 200 proceeds to a block 260.

In the decision block 245, the computer 105 determines the anomaly score for the anomaly, as described above. In response to the anomaly score exceeding a threshold, the process 200 proceeds to a block 250. In response to the anomaly score being below the threshold, the process 200 proceeds to a block 265.

In the block 250, the computer 105 performs the multifactor authentication, as described above.

Next, in a decision block 255, the computer 105 determines whether the multifactor authentication has been received, as described above. Upon receiving the multifactor authentication, the process 200 proceeds to the block 260. Without receiving the multifactor authentication, the process 200 proceeds to the block 295.

In the block 260, the computer 105 permits the vehicle 100 to start (e.g., using one of the methods described above). After the block 260, the process 200 ends.

In the block 265, the computer 105 determines the location score of the current location of the vehicle 100, as described above.

Next, in a decision block 270, the computer 105 determines whether the location score exceeds a threshold, as described above. In response to the location score exceeding the threshold, the process 200 proceeds to a block 285. In response to the location score being below the threshold, the process 200 proceeds to a block 275.

In the block 275, the computer 105 outputs a prompt instructing the operator to provide a specific authentication, such as a single-factor authentication via the user interface 135 or a biometric authentication. An authentication via the user interface 135 may demonstrate that the operator has access to the passenger compartment of the vehicle 100.

Next, in a decision block 280, the computer 105 determines whether the authentication requested in the block 275 has been received. Upon receiving the single-factor authentication (e.g., the authentication via the user interface 135 or the biometric authentication), the process 200 proceeds to the block 260 to permit the vehicle 100 to start. Without receiving the single-factor authentication, the process 200 proceeds to the block 295.

In the block 285, the computer 105 transitions the vehicle 100 to the lockdown mode, as described above. If the vehicle 100 is already in the lockdown mode because the block 220 above was executed, the computer 105 may maintain the vehicle 100 in the lockdown mode, or the computer 105 may transition the vehicle 100 from a first lockdown mode to a second lockdown mode. The second lockdown mode may be more restrictive than the first lockdown mode.

Next, in a decision block 290, the computer 105 determines whether the physical key 145 has been inserted into the vehicle 100. Upon insertion of a physical key 145 into the vehicle 100, the process 200 proceeds to the block 260 to permit the vehicle 100 to start. Without insertion of the physical key 145 into the vehicle 100, the process 200 proceeds to the block 295.

In the block 295, the computer 105 blocks starting the vehicle 100. The computer 105 maintains the lockdown mode. After the block 295, the process 200 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner’s/user’s manual and/or safety guidelines.

The disclosure has been described in an illustrative manner, and it is to be understood that the terminology which has been used is intended to be in the nature of words of description rather than of limitation. Use of “in response to,” “upon receiving,” “upon determining,” “upon insertion,” etc. indicates a causal relationship, not merely a temporal relationship. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A. computer comprising a processor and a memory, the memory storing instructions executable by the processor to:
while a vehicle is off, detect an anomaly in an external environment surrounding the vehicle by executing a long short-term memory algorithm, wherein sensor data measuring the external environment is an input to the long short-term memory algorithm;
in response to detecting the anomaly, permit starting the vehicle upon receiving a multifactor authentication, and block starting the vehicle without receiving the multifactor authentication; and
in response to not detecting the anomaly, permit starting the vehicle upon receiving a single-factor authentication.

2. The computer of claim 1, wherein the long short-term memory algorithm is more likely to detect an anomaly in response to the sensor data indicating a person holding a tool.

3. The computer of claim 1, wherein the long short-term memory algorithm is more likely to detect an anomaly in response to the sensor data indicating a person wearing a face covering.

4. The computer of claim 1, wherein a current location of the vehicle is an input to the long short-term memory algorithm.

5. The computer of claim 1, wherein sensors that produce the sensor data are inactive by default when the vehicle is off, and the instructions further include instructions to, in response to receiving data indicating motion of the vehicle while the vehicle is off, activate the sensors.

6. The computer of claim 1, wherein sensors that produce the sensor data are inactive by default when the vehicle is off, and the instructions further include instructions to, in response to an attempt to start the vehicle while the vehicle is off, activate the sensors.

7. The computer of claim 1, wherein the instructions further include instructions to:
determine a location score of a current location of the vehicle; and
in response to the location score exceeding a threshold, permit starting the vehicle upon insertion of a physical key into the vehicle, and block starting the vehicle without insertion of the physical key into the vehicle.

8. The computer of claim 1, wherein the instructions further include instructions to, in response to detecting the anomaly and detecting a mobile device of an operator of the vehicle within range of the vehicle, permit starting the vehicle upon receiving an authentication via the mobile device.

9. The computer of claim 8, wherein the instructions further include instructions to, in response to detecting the anomaly and not detecting the mobile device within range of the vehicle, permit starting the vehicle upon receiving a biometric authentication.

10. The computer of claim 1, wherein the instructions further include instructions to, in response to detecting the anomaly, lock the vehicle.

11. The computer of claim 1, wherein the instructions further include instructions to, in response to detecting the anomaly, transmit a message to a mobile device of an operator of the vehicle.

12. The computer of claim 1, wherein the instructions further include instructions to, in response to detecting the anomaly, transition the vehicle to a lockdown mode in which CAN bus messages to start the vehicle are disregarded.

13. The computer of claim 1, wherein the instructions further include instructions to, in response to detecting the anomaly and not detecting a mobile device of an operator of the vehicle within range of the vehicle, determine an anomaly score for the anomaly.

14. The computer of claim 13, wherein the instructions further include instructions to, in response to the anomaly score exceeding a threshold, permit starting the vehicle upon receiving a multifactor authentication, and block starting the vehicle without receiving the multifactor authentication.

15. A. method comprising:
while a vehicle is off, detecting an anomaly in an external environment surrounding the vehicle by executing a long short-term memory algorithm, wherein sensor data measuring the external environment is an input to the long short-term memory algorithm;
in response to detecting the anomaly, permitting starting the vehicle upon receiving a multifactor authentication, and blocking starting the vehicle without receiving the multifactor authentication; and
in response to not detecting the anomaly, permitting starting the vehicle upon receiving a single-factor authentication.

16. The method of claim 15, wherein the long short-term memory algorithm is more likely to detect an anomaly in response to the sensor data indicating a person holding a tool.

17. The method of claim 15, wherein the long short-term memory algorithm is more likely to detect an anomaly in response to the sensor data indicating a person wearing a face covering.

18. The method of claim 15, wherein sensors that produce the sensor data are inactive by default when the vehicle is off, the method further comprising, in response to receiving data indicating motion of the vehicle while the vehicle is off, activating the sensors.

19. The method of claim 15, wherein sensors that produce the sensor data are inactive by default when the vehicle is off, the method further comprising, in response to an attempt to start the vehicle while the vehicle is off, activating the sensors.

20. The method of claim 15, further comprising:
determining a location score of a current location of the vehicle; and
in response to the location score exceeding a threshold, permitting starting the vehicle upon insertion of a physical key into the vehicle, and blocking starting the vehicle without insertion of the physical key into the vehicle.
